(19) United States
(12) Patent Application Publication
(10) Pub. No.: US 2004/0174528 A1
(43) Pub. Date: Sep. 9, 2004

(54) Schemes for computing performance parameters of fiber optic gyroscopes

(76) Inventor: Ian Humphrey, Foxboro, MA (US)

Correspondence Address: PATTI & BRILL, ONE NORTH LASALLE STREET, 44TH FLOOR, CHICAGO, IL, 60602, US

(21) Appl. No.: 10/761,592

(22) Filed: Jan. 21, 2004

Related U.S. Application Data
(60) Provisional application No. 60/442,634, filed on Jan. 24, 2003.

(51) Int. Cl. G01C 19/72

(52) U.S. Cl. 356/464; 702/92

(57) ABSTRACT

Schemes for computing performance parameters of fiber-optic gyroscopes (FOGs) using closed-loop transfer functions are described herein. In one embodiment, a method to compute a performance parameter of a FOG may include providing a closedloop transfer function based on optical components and electrical components of the FOG; based on the transfer function, determining a relationship between the performance parameter and at least one physical parameter associated with at least one component of the FOG; and, based on the relationship, computing the performance parameter.

### CROSS-REFERENCE TO RELATED APPLICATION

This application claims the priority of U.S. provisional Patent Application Serial No. 60/442,634 (by Humphrey, filed Jan. 24, 2003, and entitled “SCHEMES FOR COMPUTING PERFORMANCE PARAMETERS OF FIBER OPTIC GYROSCOPES”).

### BACKGROUND

(1) Field

The present disclosure relates to schemes for computing performance parameters of fiber optic gyroscopes (FOGs) using closed-loop transfer functions.

(2) Description of Related Art

A FOG is a device that can detect rotation in a variety of applications, including navigation and stabilization schemes. Generally, a FOG can include an optical subsystem and an electrical subsystem. The optical and electrical subsystems can provide inputs to each other.

A FOG can be characterized by a variety of performance parameters, including an operating frequency and a bandwidth. Generally, schemes for computing FOG performance parameters separately model FOG optical and electrical subsystems with two open-loop systems. Since FOGs can operate with their optical and electrical subsystems in a closed-loop configuration, however, meaningful conclusions cannot be reliably provided by two open-loop systems.

### SUMMARY

Schemes for computing performance parameters of FOGs using closed-loop transfer functions are described herein.

A method for computing a performance parameter of a FOG is described herein. In one embodiment, the method may include providing a closed-loop transfer function based on optical components and electrical components of the FOG; based on the transfer function, determining a relationship between the performance parameter and at least one physical parameter associated with at least one component of the FOG; and, based on the relationship, computing the performance parameter.

In one aspect, providing may include providing a feedforward component representing at least one FOG optical component and at least one FOG electronic component; and, providing a feedback component representing at least one FOG optical component and at least one FOG electronics component.

In one aspect, providing a feedforward component may include representing, in the feedforward component, at least one noise component.

In one aspect, providing a feedforward component may include representing, in the feedforward component, at least one disturbance, wherein the at least one disturbance is based on at least one of: an optical power noise, a shot noise, a preamplifier current noise, a preamplifier thermal noise, a preamplifier voltage noise, and an analog-to-digital converter (ADC) quantization noise.

In one aspect, providing a feedforward component may include representing, in the feedforward component, at least one of: a phase modulator, a photodetector and an associated preamplifier, a filter, an ADC, and a sampler.

In one aspect, representing the phase modulator may include representing the phase modulator based on an optical power of a light beam propagating through a fiber-optic coil and an operating phase bias.

In one aspect, representing the phase modulator may include representing the phase modulator based on a product of the optical power and a sinusoidal function of the operating phase bias.

In one aspect, representing the photodetector and the associated preamplifier may include representing the photodetector and the associated preamplifier based on a photodetector scale factor, a preamplifier impedance, and a preamplifier gain.

In one aspect, representing the photodetector and the associated preamplifier may include representing the photodetector and the associated preamplifier based on a product of the photodetector scale factor, the preamplifier impedance, and the preamplifier gain.

In one aspect, representing the filter may include representing the filter as a gain in voltage after the photodetector and associated preamplifier and before the ADC.

In one aspect, representing the ADC may include representing the ADC as a gain based on the number of bits in the ADC.

In one aspect, providing a feedback component may include representing, in the feedback component, at least one of: sampler, a truncator, a digital-to-analog converter (DAC), a phase modulator, and a fiber-optic coil.

In one aspect, representing the truncator may include representing the truncator as a digital truncation gain.

In one aspect, representing the DAC may include representing the DAC as a gain based on the number of bits in the DAC.

In one aspect, representing the phase modulator may include representing the phase modulator as a scale factor.

In one aspect, representing the fiber-optic coil may include representing the fiber-optic coil as a time delay.

In one aspect, representing the fiber-optic coil may include representing the fiber-optic coil based on a transit time for a light beam to propagate through the fiber-optic coil.

In one aspect, determining a relationship may include, based on the transfer function, determining a relationship between the performance parameter and at least one physical parameter associated with at least one component of the FOG, wherein the at least one physical parameter includes at least one of:

an optical power of a light beam propagating through a fiber-optic coil, an operating phase bias, a photodetector scale factor, a preamplifier impedance, a preamplifier gain, a filter gain, an ADC gain, a digital truncation gain, a DAC gain, a transit time for a light beam to propagate through the fiber-optic coil, and a phase modulator scale factor.

In one aspect, computing may include providing an input based on a rate of rotation of a fiber-optic coil and a scale factor, the scale factor including a wavelength of a light beam propagating through the coil, a coil length, and a coil diameter.

In one aspect, computing may include computing a performance parameter including at least one of a bandwidth, a coefficient of random walk, an operating frequency, and a power spectral density of noise.

In one embodiment, the method may further include providing a value of a performance parameter and determining at least one value associated with the at least one physical parameter for which the computed performance parameter will have the value.

In one aspect, determining the at least one value may include providing at least one initial value associated with the at least one physical parameter; based on the relationship and the at least one initial value, computing the performance parameter; and, based on a difference between the computed performance parameter and the value, iteratively adjusting at least one value associated with the at least one physical parameter and iteratively computing the performance parameter.

In one embodiment, the method may further include providing a first value of a first performance parameter; providing a second value of a second performance parameter; and, determining at least one value associated with the at least one physical parameter for which the computed first performance parameter will approach the first value and the computed second performance parameter will approach the second value.

In one aspect, determining at least one value may include providing at least one initial value associated with the at least one physical parameter; based on the corresponding relationship and the at least one initial value, computing the first performance parameter and the second performance parameter; and, based on a difference between at least one of the first value and the computed first performance parameter and the second value and the computed second performance parameter, iteratively adjusting at least one value associated with the at least one physical parameter and iteratively computing the first performance parameter and the second performance parameter.

A processor program for computing a performance parameter of a fiber-optic gyroscope (FOG) is described herein. In one embodiment, the processor program may be stored on a processor-readable medium and may include instructions to cause a processor to receive a closed-loop transfer function based on optical components and electrical components of the FOG; based on the transfer function, determine a relationship between the performance parameter and at least one physical parameter associated with at least one component of the FOG; and, based on the relationship, computing the performance parameter.

In one aspect, the instructions to compute may include instructions to compute a performance parameter including at least one of a bandwidth, a coefficient of random walk, an operating frequency, and a power spectral density of noise.

In one embodiment, the processor program may also include instructions to receive a value of a performance parameter, and determine at least one value associated with the at least one physical parameter for which the computed performance parameter will have the value.

In one aspect, the instructions to determine may include instructions to receive at least one initial value associated with the at least one physical parameter; based on the relationship and the at least one initial value, compute the performance parameter; and, based on a difference between the computed performance parameter and the value, iteratively adjust at least one value associated with the at least one physical parameter and iteratively compute the performance parameter.

In one embodiment, the processor program may also include instructions to receive a first value of a first performance parameter; receive a second value of a second performance parameter; and, determine at least one value associated with the at least one physical parameter for which the computed first performance parameter will approach the first value and the computed second performance parameter will approach the second value.

In one aspect, the instructions to determine may include instructions to receive at least one initial value associated with the at least one physical parameter; based on the corresponding relationship and the at least one initial value, compute the first performance parameter and the second performance parameter; and, based on a difference between at least one of the first value and the computed first performance parameter, and the second value and the computed second performance parameter, iteratively adjust at least one value associated with the at least one physical parameter and iteratively compute the first performance parameter and the second performance parameter.

These and other features of the schemes for computing performance parameters of FOGs described herein may be more fully understood by referring to the following detailed description and accompanying drawings.

### BRIEF DESCRIPTION OF THE DRAWINGS

FIG. 1 is a block diagram of an exemplary closed-loop transfer function for a FOG.

FIG. 2 is a block diagram of an exemplary feedforward component of the closed-loop transfer function shown in FIG. 2

FIG. 3 schematically illustrates a prior-art FOG.

### DETAILED DESCRIPTION

Certain exemplary embodiments will now be described to provide an overall understanding of the schemes for computing performance parameters of FOGs described herein. One or more examples of the exemplary embodiments are shown in the drawings.

Those of ordinary skill in the art will understand that the schemes for computing performance parameters of FOGS described herein can be adapted and modified to provide devices, methods, schemes, and systems for other applications, and that other additions and modifications can be made to the schemes described herein without departing from the scope of the present disclosure. For example, components, features, modules, and/or aspects of the exemplary embodiments can be combined, separated, interchanged, and/or rearranged to generate other embodiments. Such modifications and variations are intended to be included within the scope of the present disclosure.

Generally, the exemplary schemes described herein include a closed-loop representation of FOG optical subsystem components and FOG electrical subsystem components to compute performance parameters for FOGs. In one embodiments a closed-loop transfer function can be used to determine a relationship between a FOG performance parameter and physical parameter(s) associated with FOG component(s). The relationship can be used to determine value(s) of the physical parameter(s) for which the performance parameter will approach a performance parameter value.

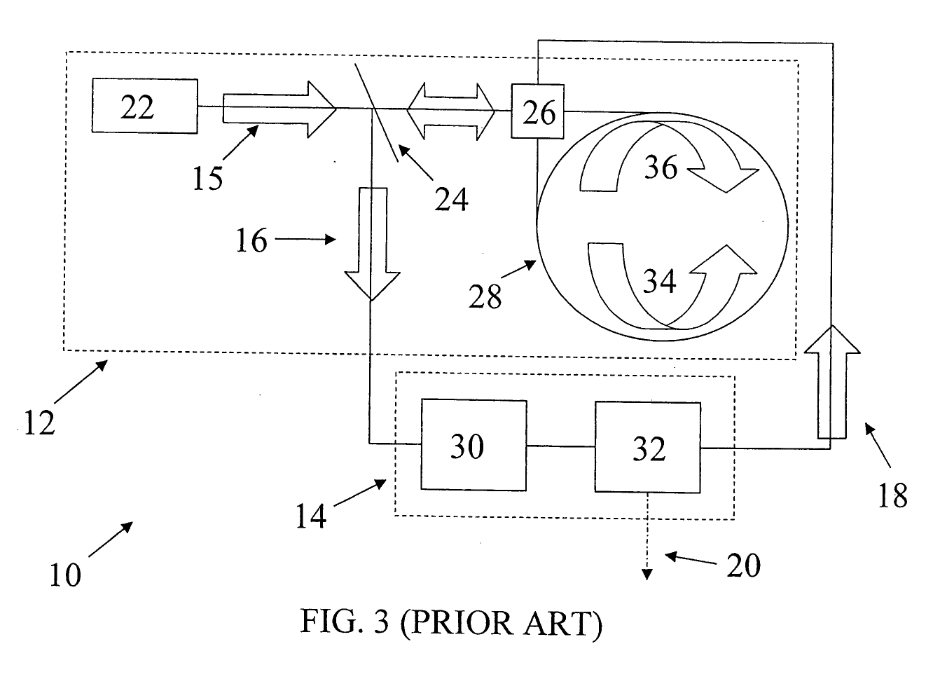

FIG. 3 schematically illustrates a prior-art FOG. FOGs are well known and may be understood by referring to the disclosures of U.S. Pat. Nos. 4,705,399 to Graindorge et al. and U.S. Pat. No. 5,337,142 to Lefevre et al., the contents of which patents are expressly incorporated by reference herein.

As shown in FIG. 3, FOG 10 may include an optical subsystem 12 and an electrical subsystem 14. Optical subsystem 12 may include a light source 22, a beam splitter 24, a phase modulator 26, and an optical waveguide 28. Electrical subsystem 14 may include a signal digitizer 30 and a demodulator 32. Optical subsystem 12 can provide a signal 16 to electrical subsystem 14, and electrical subsystem 14 can provide a feedback signal 18 to optical subsystem 12. Electrical subsystem 14 can also provide a signal 20 to an application. FOG components 22, 24, 26, 28, 30, and 32 may be connected by optical and/or electrical connection(s) and may communicate with component(s) other than those illustrated.

Operation of FOG 10 may be briefly understood in the following manner. Light source 22 can provide a light signal 15 to beam splitter 24, and beam splitter 24 can split the light signal into two light signals that travel in opposite directions 34, 36 along an optical path defined by optical waveguide 28. Beam splitter 24 can receive the two light signals exiting from optical waveguide 28, combine the two light signals, and provide the combined light signal 16 to signal digitizer 30. Based on the combined light signal 16, signal digitizer 30 can produce an output signal proportional to a phase difference between the two light signals exiting the optical waveguide 28. According to the well known Sagnac effect, this phase difference can be used to measure a rate of rotation of the optical waveguide 28.

A variety of schemes for adjusting the operating point of a FOG 10 are available. Generally, these schemes superimpose artificial phase differences on the two light signals 34, 36 counterpropagating in the optical waveguide 28. In these schemes, the output from the signal digitizer 30 can be provided to the demodulator 32, and the demodulator 32 can provide a feedback signal 18 to phase modulator 26 to modulate the relative phases of the counterpropagating light beams.

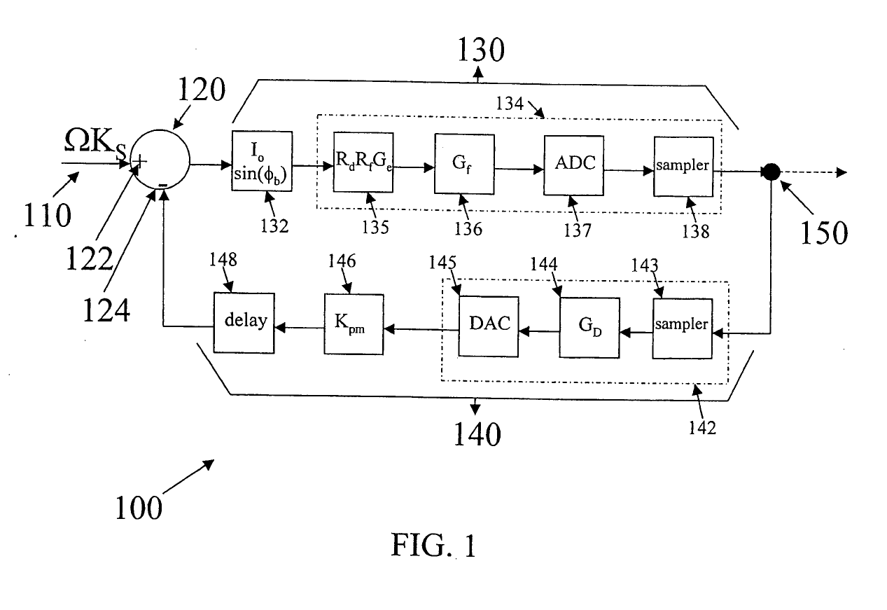

FIG. 1 is a block diagram of an exemplary closed-loop transfer function for FOG 10. As shown in FIG. 1, the transfer function 100 may include an input 110, a summing point 120, a feedforward component 130, a feedback component 140, and a branch point 150. Input 110 and feedback component 140 may be provided to positive and negative terminals 122, 124 of summing point 120, respectively. As described herein, transfer function 100 may be used to compute an operating frequency and bandwidth of FOG 10. Appendices 1-5 include features of transfer function 100 described herein.

Generally, input 110 may be based on a rate of rotation of an optical waveguide 28 and a scale factor. Input 110 may be based on a product or the rate of rotation and the scale factor. In one embodiment, the scale factor may include a wavelength of light propagating through the optical waveguide 28, an optical path length of the optical waveguide 28, and a diameter of the optical waveguide 28. The scale factor may be associated with the well known Sagnac scale factor. For example, in one embodiment of FOG 10, an optical waveguide 28 may include a coil of optical fiber wound on a spool-type structure, such as a bobbin, and a light source 22 that can be, for example, a superluminescent diode (SLD). In such an embodiment, the input 110 may be represented as the product

$$Ω {K}_{s} = \frac{Ω ( 2 π LD )}{λ} \qquad ( Eq . 1 )$$

where Q is the rate of rotation of the coil, K, is the well known Sagnac scale factor, L is the length of the coil, D is the diameter of the coil, λ is the wavelength of light emitted by the SLD, and c is the speed of light in vacuo.

Feedforward component 130 may include representations of at least one FOG optical component and at least one FOG electrical component. As shown in FIG. 1, feedforward component 130 may include a representation 132 of a phase modulator 26. In one embodiment, phase modulator 26 may be represented based on an optical power of light emitted by light source 22 and an operating phase bias of FOG 10. An operating phase bias can refer to a phase bias applied to counterpropagating light beams 34, 36 in optical waveguide 28 to displace the operating point of FOG 10. In one embodiment, the phase modulator 26 may be represented based on a product of the optical power and a sinusoidal function of the operating phase bias. For example, the phase modulator may be based on the product

K₁=Iₒ sin(φ_{b}), (Eq. 2)

where Iₒ is the optical power of light source 22 and φ_{b} is the operating phase bias of FOG 10.

Feedforward component 130 may also include a representation 134 of a signal digitizer 30. Generally, a signal digitizer 30 may include a light detector, an analog-to-digital converter (ADC), filter(s), and other processing component(s). A variety of signal digitizers may be represented based on schemes described herein.

In one embodiment, the signal digitizer 30 may be represented as including a photodetector and an associated preamplifier 135, a filter 136, an ADC 137, and a sampler 138. The photodetector and associated preamplifier 135 may be represented based on a photodetector scale factor R_{d}, a preamplifier impedance R_{f} and a preamplifier gain Gee The photodetector scale factor R_{d} may represent a scale factor between an input optical power and an output analog signal, e.g. current or voltage. In one embodiment, the photodetector and associated preamplifier 135 may be represented based on the product of the photodetector scale factor R_{d}, the preamplifier impedance R_{f}, and the preamplifier gain Gₑ. The ADC 137 may be represented as a gain based on a number of bits b in the ADC 137. In one embodiment, the ADC 137 may be represented as a gain based on the power 2^{b-1}. In one embodiment, the filter 136 may be represented as a gain G_{f} in voltage after the photodetector and associated preamplifier 135 and before the ADC 137. The sampler 138 may be represented as a sampler for analog-to-digital conversion. Accordingly, in one embodiment, the signal digitizer 30 may be represented based on the product

R_{d}R_{f}GₑG_{f}2^{b-1}. (Eq. 3)

Feedback component 140 may include representations of at least one FOG optical component and at least one FOG electrical component. Feedback component 140 may include a representation 142 of a demodulator 32. Generally, a demodulator 32 may include a sampler, a truncator, a digital-to-analog converter (DAC), and other processing component(s). A variety of demodulators may be represented based on schemes described herein.

In one embodiment, the demodulator 32 may be represented as including a sampler 143, a truncator 144, and a DAC 145. The sampler 143 may be represented as a sampler for digital-to-analog conversion. The truncator 144 may be represented as a digital truncation gain G_{D} that occurs after the sampler 143 and before the DAC 145. In one embodiment, the digital truncation gain G_{D} may be based on the number of bits d′ in the sampler 143 and the number of bits d in the DAC 145. For example, the digital truncation gain G_{D} may be based on the power 2^{d-d′}. The DAC 145 may be represented as a gain based on the number of bits d in the DAC 145. In one embodiment, the DAC 145 may be represented as a gain based on the power 2^{2-d}. Accordingly, in one embodiment, the demodulator 30 may be represented based on the product

2^{d-d′}2^{2-d}=2^{2-d′}. (Eq. 4)

Feedback component 140 may include a representation 146 of a phase modulator 26. In one embodiment, phase modulator 26 may be represented based on a phase modulator scale factor Kₚₘ. The phase modulator scale factor Kₚₘ may represent a scale factor between an input analog signal, e.g. current or voltage, and an output angular measure.

Feedback component 140 may also include a representation 148 of an optical waveguide 28. In one embodiment, the optical waveguide 28 may be represented as a time delay. The optical waveguide 28 may be represented as a transit time τ for light to

propagate through optical waveguide 28. For example, as previously described, an optical waveguide 28 may include a coil of optical fiber. In such an embodiment, the optical waveguide 28 may be represented based on a transit time

τ=nL/c, (Eq. 5)

where L is the length of the coil and n is the index of refraction of the optical fiber.

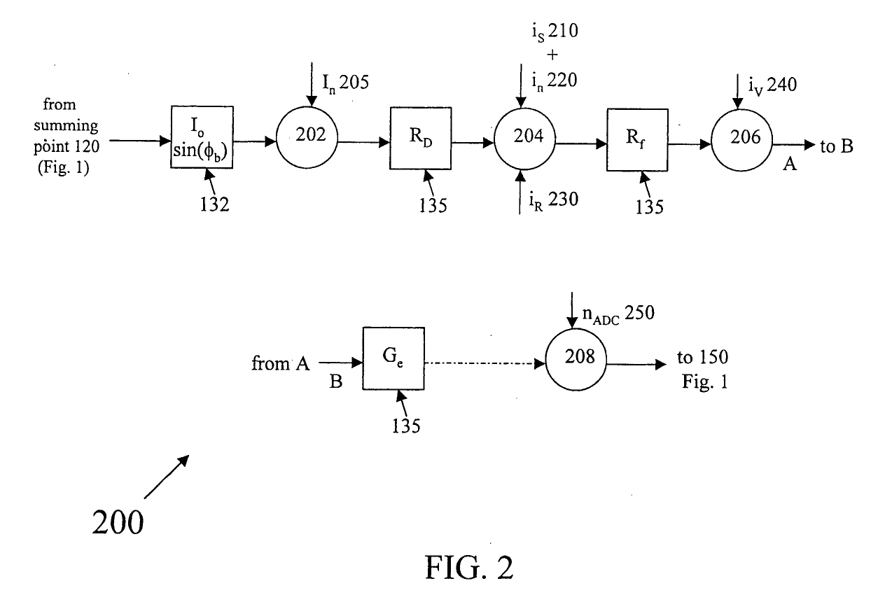

FIG. 2 is a block diagram of an embodiment of an exemplary feedforward component for a closed-loop transfer function 100 according to FIG. 1. As shown in FIG. 2, feed forward component 200 may include disturbances at summing points 202, 204, 206, and 208 based on an optical power noise Iₙ 205, a shot noise iₛ 210, a preamplifier current noise in 220, a preamplifier thermal noise i_{R} 230, a preamplifier voltage noise i_{V} 240, and an ADC quantization noise n_{ADC} 250. As described herein, a transfer function 100 having a feedforward component 200 may be used to compute a coefficient of random walk (CRW) and a power spectral density (PSD) of noise of FOG 10.

A PSD of shot noise iₛ 210 may be represented based on a photodetector current i_{D}. In one embodiment, a PSD of shot noise iₛ 210 may be represented based on the product

2qi_{D}=2qIₒR_{D}(1+cos(φ_{b})) (Eq. 6)

where 1^{o′}R_{d}, and φ_{b} have been previously defined, and q is the charge of the electron.

A PSD of preamplifier thermal noise i_{V} 230 may be represented based on a temperature T_{K} of the FOG 10 and a preamplifier impedance R_{f}. In one embodiment, a PSD of thermal noise i_{R} 230 may be represented based on the product

4 kT_{K}/R_{f}, (Eq. 7)

where k is Boltzmann's constant.

A PSD of preamplifier voltage noise i_{V} 240 may be represented based on a preamplifier voltage eₙ, a preamplifier noise gain Gₙ, and a preamplifier impedance R_{f}. In one embodiment, a PSD of preamplifier voltage noise iᵥ 240 may be represented based on the product

(eₙGₙ/R_{f}) 2. (Eq. 8)

A PSD of ADC quantization noise n_{ADC} 250 may be represented based on an ADC sample period t, a preamplifier impedance R_{f} a filter gain G_{f}, and a number of bits b in ADC 137. In one embodiment, a PSD of ADC quantization noise n_{ADC} 250 may be represented based on the product

2t/[12(R_{f}G_{f}2^{b-1})²] (Eq. 9)

PSDs of optical power noise Iₙ 205 and preamplifier current noise iₙ 220 may be represented based on schemes familiar to those of ordinary skill in the art.

Generally, transfer function 100 may be manipulated using well known control system transform theory to determine relationships between FOG performance parameters and physical parameter(s) associated with FOG component(s). Appendices 1-5 include features related to manipulation of transfer function 100. Relationships for an operating frequency, a bandwidth, a PSD of noise, and a CRW are provided immediately below. As shown, these relationships may depend on FOG physical parameter(s) including at least one of an optical power Iₒ of light transmitted by a light source 22, an operating phase bias φ_{b}, a photodetector scale factor R_{d}, a preamplifier impedance R_{f}, a preamplifier gain Gₑ, a filter gain G_{f}, an ADC gain 2^{b-1}, a phase modulator scale factor Kₚₘ, and a transit time τ.

Based on a transfer function 100 having a feedforward component 130, an operating frequency ωₒ for a FOG 10 may be expressed as

ωₒ=Iₒ·sin(φ_{b})·R_{d}·R_{f}·Gₑ·G_{f}·2^{b-1}·1/τ·G_{D}·2^{2-d′}·Kₚᵢₙ· (Eq. 10)

Based on a transfer function 100 having a feedforward component 130, a 90° bandwidth BW90 for a FOG 10 may be expressed as

BW90=(180/π·arg(H(e^{iwt}, Iₒ))+90)^{1/2}, (Eq. 11)

where H(z, Iₒ) is defined by the equation

$$H ( z , {I}_{0} ) = {ω}_{0} \cdot τ \cdot \frac{{z}^{- ( N + 1 )}}{1 - {z}^{- 1} + {ω}_{0} \cdot τ \cdot {z}^{- ( N + M + 1 )}} \cdot {z}^{- 2} , \qquad ( Eq . 12 )$$

in which N and M are described in Appendices 1-5, as those of ordinary skill in the art will understand.

Based on a transfer function 100 having a feedforward component 130, a 3 dB bandwidth BW3 for a FOG 10 may be expressed as

$$BW3 = {( ( \vert H ( {ⅇ}^{ⅈ ωτ} , {I}_{0} ) \vert ) - \frac{1}{\sqrt{2}} )}^{\frac{1}{2}} . \qquad ( Eq . 13 )$$

Based on a transfer function 100 having a feedforward component 230, a PSD of noise for a FOG 10 may be expressed as

$$PSD = \frac{1}{{( {K}_{s} \cdot {K}_{I} \cdot {K}_{D} )}^{2}} \cdot [ 2 \cdot q \cdot {I}_{D} + ( \frac{4 \cdot k \cdot {T}_{K}}{{R}_{f}} ) + {i}_{n}^{2} + \\ \frac{{G}_{n}^{2} \cdot {e}_{n}^{2}}{{R}_{f}^{2}} + \frac{1}{{( {R}_{f} \cdot {G}_{f} \cdot {2}^{b - 1} )}^{2}} \cdot \frac{2 \cdot t}{12} ] . \qquad ( Eq . 14 )$$

Based on a transfer function 100 having a feedforward component 230, a CRW for a FOG 10 may be expressed as

$$CRW = 60 \cdot \frac{180}{π} \cdot \sqrt{\frac{PSD}{2}} . \qquad ( Eq . 15 )$$

Based on the relationships provided in Eqs. 10-15, performance parameters for a FOG 10 may be computed. Generally, a performance parameter may be computed by substituting values of physical parameter(s) in the corresponding relationship for the performance parameter. For example, an operating frequency of a pre-existing FOG may be computed by substituting the values of the physical parameters of the FOG in the relationship for the operating frequency provided herein. As previously indicated, physical parameters can include, for example, at least one of an optical power Iₒ of light transmitted by a light source 22, an operating phase bias φ_{b}, a photodetector scale factor R_{d}, a preamplifier impedance R_{f}, a preamplifer gain Gₑ, a filter gain G_{f}, an ADC gain 2^{b-1}, a digital truncation gain G_{D}, a DAC gain 2^{2-d}, a phase modulator scale factor Kₚₘ, and a transit time τ.

The relationships provided in Eqs. 10-15 may be used to design a FOG having desired performance parameter value(s). In one embodiment, performance parameter value(s) may be provided. Based on the relationship(s) corresponding to the performance parameter(s), value(s) associated with physical parameter(s) may be determined for which the computed performance parameter(s) will have or approach the performance parameter value(s). Initial value(s) associated with physical parameter(s) may also be provided. The performance parameter(s) may be computed based on the corresponding relationship(s) and the initial value(s). If a difference can be determined between the computed performance parameter(s) and the performance parameter value(s), then value(s) associated with physical parameter(s) may be iteratively adjusted, and the performance parameter(s) may be iteratively computed based on the iteratively adjusted value(s). For example, a desired value of an operating frequency may be provided, and values of physical parameter(s) may be determined for which a FOG will have the operating frequency value. Also for example, desired values of an operating frequency and a PSD of noise may be provided, and value(s) of physical parameters may be determined for which the operating frequency and the PSD of noise approach the desired values. Generally, the relationships provided in Eqs. 10-15 may be used with regression schemes familiar to those of ordinary skill in the art.

The schemes described herein are not limited to a particular hardware or software configuration; they may find applicability in many computing or processing environments. The schemes can be implemented in hardware or software, or in a combination of hardware and software. The schemes can be implemented in one or

more computer programs, in which a computer program can be understood to include one or more processor-executable instructions. The computer program(s) can execute on one or more programmable processors, and can be stored on one or more storage media readable by the processor, including volatile and nonvolatile memory and/or storage elements. The programmable processor(s) can access one or more input devices to obtain input data and one or more output devices to communicate output data.

The computer program(s) can be implemented in high level procedural or object oriented programming language to communicate with a computer system. The computer program(s) can also be implemented in assembly or machine language. The language can be compiled or interpreted.

The computer program(s) can be stored on a storage medium or a device (e.g., compact disk (CD), digital video disk (DVD), magnetic disk, internal hard drive, external hard drive, random access memory (RAM), redundant array of independent disks (RAID), or memory stick) that is readable by a general or special purpose programmable computer for configuring and operating the computer when the storage medium or device is read by the computer to perform the schemes described herein.

While the schemes described herein have been particularly shown and described with reference to certain exemplary embodiments, those of ordinary skill in the art will understand that various changes may be made in the form and details of the schemes described herein without departing from the spirit and scope of the present disclosure.

For example, transfer function 100 may be modified based on schemes described herein to compute performance parameters of FOGs including components and/or arrangements of components similar to or different than those of FOG 10 shown in FIG. 3.

Those of ordinary skill in the art will recognize or be able to ascertain many equivalents to the exemplary embodiments described herein by using no more than routine experimentation. Such equivalents are intended to be encompassed by the scope of the present disclosure. Accordingly, the present disclosure is not to be limited to the embodiments described herein and can include practices other than those described, and is to be interpreted as broadly as allowed under prevailing law.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A process, comprising the step of:
computing one or more parameters of a fiber optic gyroscope through employment of a closed-loop transfer function based on one or more characteristics of:
one or more optical components of the fiber optic gyroscope; and
one or more electrical components of the fiber optic gyroscope.

2. The process of claim 1, wherein the step of computing the one or more parameters of the fiber optic gyroscope through employment of the closed-loop transfer function based on the one or more characteristics of the one or more optical components of the fiber optic gyroscope and the one or more electrical components of the fiber optic gyroscope comprises the step of:
computing one or more performance parameters of the fiber optic gyroscope through employment of one or more physical parameters of one or more of the one or more optical components and one or more of the one or more electrical components.

3. The process of claim 2, wherein the step of computing the one or more performance parameters of the fiber optic gyroscope through employment of the one or more physical parameters of the one or more of the one or more optical components and the one or more of the one or more electrical components comprises the steps of:
determining one or more relationships between the one or more performance parameters and the one or more physical parameters; and
employing one or more of the one or more relationships to compute the one or more performance parameters.

4. The process of claim 3, wherein the step of employing the one or more of the one or more relationships to compute the one or more performance parameters comprises the steps of:
substituting one or more known values of the one or more physical parameters into the one or more relationships; and
employing the one or more known values of the one or more physical parameters to compute the one or more performance parameters.

5. The process of claim 3, further comprising the step of:
determining one or more desired values of the one or more physical parameters for employment in causation of the one or more performance parameters to equal or approach one or more provided performance parameter values for the fiber optic gyroscope.

6. The process of claim 5, wherein the step of determining the one or more desired values of the one or more physical parameters for employment in causation of the one or more performance parameters to equal or approach the one or more provided performance parameter values for the fiber optic gyroscope comprises the step of:
employing the one or more desired values of the one or more physical parameters to design the fiber optic gyroscope to equal or approach the one or more provided performance parameter values.

7. The process of claim 3, wherein the step of employing the one or more of the one or more relationships to compute the one or more performance parameters comprises the step of:
employing the one or more of the one or more relationships and one or more initial values of the one or more physical parameters to compute the one or more performance parameters.

8. The process of claim 7, wherein the step of employing the one or more of the one or more relationships and the one or more initial values of the one or more physical parameters to compute the one or more performance parameters comprises the steps of:
determining a difference between the one or more performance parameters and one or more provided parameter values for the fiber optic gyroscope;
iteratively adjusting one or more of the one or more initial values of one or more of the one or more physical parameters through employment of the one or more of the one or more relationships; and
iteratively computing the one or more performance parameters through employment of the one or more relationships and the one or more of the one or more initial values.

9. The process of claim 2, wherein the one or more physical parameters comprise one or more of:
an optical power of a light beam in a representation of a first phase modulator in a representation of a feedforward component of the closed-loop transfer function of the fiber optic gyroscope;
an operating phase bias applied to one or more counterpropagating light beams in the representation of the first phase modulator in the representation of the feedforward component of the closed-loop transfer function of the fiber optic gyroscope;
a photodetector scale factor in a representation of a photodetector in a representation of a signal digitizer in the representation of the feedforward component of the closed-loop transfer function of the fiber optic gyroscope;
a preamplifier impedance in a representation of a preamplifier in the representation of the signal digitizer in the representation of the feedforward component of the closed-loop transfer function of the fiber optic gyroscope;
a preamplifier gain of the preamplifier in the representation of the signal digitizer in the representation of the feedforward component of the closed-loop transfer function of the fiber optic gyroscope;
a gain in voltage in a representation of a filter after the photodetector and the preamplifier and before an analog-to-digital converter in the representation of the signal digitizer in the representation of the feedforward component of the closed-loop transfer function of the fiber optic gyroscope;
a gain in a representation of the analog-to-digital converter of the representation of the signal digitizer in the representation of the feedforward component of the closed-loop transfer function of the fiber optic gyroscope;
a digital truncation gain in a representation of a truncator in a representation of a demodulator in a representation of a feedback component of the fiber optic gyroscope;
a transit time for the light beam to propagate through a representation of an optical waveguide in the representation of the feedback component of the closed-loop loop transfer function of the fiber optic gyroscope; and
a phase modulator scale factor in a representation of a second phase modulator in the representation of the feedback component of the closed-loop transfer function of the fiber optic gyroscope.

10. The method of claim 1, wherein the closed-loop transfer function comprises one or more of:
a summing point that receives:
an input based on a rate of rotation of an optical waveguide of a feedback component and a scale factor based on a wavelength of light propagating through the optical waveguide, an optical path length of the optical waveguide, and a diameter of the optical waveguide, as a positive input; and
an input based on a modulated first light beam and a modulated second light beam exiting the optical waveguide of the feedback component as a negative input;
wherein the summing point employs the positive input and the negative input to determine a difference between the positive input and the negative input;
a feedforward component that receives the difference between the positive input and the negative input as an input;
wherein the feedforward component employs the difference between the positive input and the negative input to provide a signal proportional to a phase difference between the modulated first light beam and the modulated second light beam exiting the optical waveguide of the feedback component as an output;
wherein the feedback component receives the signal proportional to the phase difference between the modulated first light beam and the modulated second light beam exiting the optical waveguide of the feedback component as an input;
wherein the feedback component employs the signal proportional to the phase difference between the modulated first light beam and the modulated second light beam exiting the optical waveguide of the feedback component to produce a feedback signal;
wherein the feedback component employs the feedback signal to produce the modulate first light beam and the modulated second light beam exiting the optical waveguide of the feedback component.

11. An article, comprising:
one or more storage media readable by a processor;
means in the one or more storage media for computing one or more parameters of a fiber optic gyroscope through employment of a closed-loop transfer function based on one or more characteristics of:
one or more optical components of the fiber optic gyroscope; and
one or more electrical components of the fiber optic gyroscope.

12. The article of claim 11, wherein the means in the one or more storage media for computing the one or more parameters of the fiber optic gyroscope through employment of the closed-loop transfer function based on the one or more characteristics of the one or more optical components of the fiber optic gyroscope and the one or more electrical components of the fiber optic gyroscope comprises:
means in the one or more storage media for determining one or more relationships between one or more physical parameters and one or more performance parameters of:
one or more of the one or more optical components; and
one or more of the one or more electrical components; and
means in the one or more storage media for employing one or more of the one or more relationships to determine the one or more performance parameters.

13. The article of claim 12, wherein the one or more performance parameters comprise one or more of a bandwidth of the fiber optic gyroscope, a coefficient of random walk of the fiber optic gyroscope, an operating frequency of the fiber optic gyroscope, and a power spectral density of noise of the fiber optic gyroscope.
